(19) United States
(12) Patent Application Publication
(10) Pub. No.: US 2009/0187993 A1
(43) Pub. Date: Jul. 23, 2009

(54) PROCESSOR HARDWARE AND SOFTWARE

(75) Inventor: Fabien Lefebvre, Caen (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/064,154

(22) PCT Filed: Aug. 22, 2006
(86) PCT No.: PCT/IB06/52894

§ 371 Date: Oct. 24, 2008

(30) Foreign Application Priority Data
Aug. 24, 2005 (EP) 05107757.6

(51) Int. Cl. G06F 21/00; H01L 21/00

(52) U.S. Cl. 726/26; 438/106; 257/E21.002

(57) ABSTRACT

A system and method for detecting the use of pirated software on a processor device (10), whereby said processor device (10) having a bus controller (14), is bonded so as to detect the presence of a signature contained in said software, whereby detection of said signature using said bus controller (14) disables said processor (10).

The present invention relates to a system and method for detecting the presence of software running on hardware. More specifically, it relates to a system and method for disabling said hardware upon detection of particular software and preventing the software from executing instructions on said hardware.

It is common practice for companies who manufacture processor hardware to develop, in parallel, software such as machine code or firmware specifically tailored to run on their processors. In doing so, it is generally considered that the software developed by the processor producer is optimised for achieving maximum performance from the processor device. As a result, companies often recommend that a customer purchasing a particular processor device also purchase the relevant software to achieve optimum performance from the processor.

Developing software that achieves optimum performance requires considerable investment both in terms of time and finance, and as such companies will only supply the software subject to a license preventing customers from copying the software and passing it on to third parties in an attempt to ensure that revenue for the software/hardware supplying company is not lost.

However, under certain circumstances some customers may not wish to use the software developed by the hardware manufacturing company and the hardware company will simply supply the processor on its own. Also, end users of the hardware are free to develop their own software for use with the hardware, tailored to their specific requirements.

Of course it cannot be ruled out that unauthorised or otherwise illegitimate copies of the hardware manufacturer's software, may be made available by to end users of the hardware.

Examples of unauthorised software can include copies made by a third party without obtaining the necessary authorisation, or unauthorised copies supplied through so called peer-to-peer networks. Such unauthorised copying or sharing ultimately results in loss of revenue for the software developer.

To overcome such problems, various solutions exist for preventing use of such unauthorised software, and it is well known to include encryption code in the software to prevent the unauthorised use thereof. A decryption key is implemented in hardware to decipher the encryption code allowing the executable instructions of the software to run on hardware.

As a particular example, WO-A-81/02351, discloses a proprietary processor architecture where the chip or die design is modified to include a decoder comprising a first multiplexer, an array of logic gates and a demultiplexer placed in series between the instruction register and the instruction decoder of the processor. If the instruction code is correctly implemented for use on the modified processor, the logic gates will decode the encryption code enabling the processor to execute the instruction code of the software. Conversely, the use of the encrypted software on an unmodified processor will result in incorrect execution of the instruction code and malfunction.

The above solution however as offered by WO-A-81/02351 can prove prohibitively costly in that it requires substantial amendment of the processor architecture to implement the software detection and so various versions of such architecture are required to guard against the above-mentioned unauthorised use. Furthermore, since the decryption key is implemented using logic gates, it can be subject to reverse engineering allowing it to be copied such that the software/hardware provider cannot identify with certainty that illegitimate copies of the software are being used with their hardware. Additionally, the decryption key is static and cannot be easily updated without physically rewiring the logic gates.

The present invention seeks to provide for a method and system for detecting the presence of software running on hardware and having advantages over known such methods and systems.

According to one aspect of the present invention, there is provided a processor device arranged for detecting the use of software thereon, the processor device having a bus controller arranged to detect the presence of a signature contained in the software, and arranged such that detection of the signature by way of the bus controller serves to disable the processor.

In particular the present invention seeks to prevent use of illegitimate software in relation to a processor device, which overcomes one or more of the above mentioned disadvantages and, in particular, prevents illegitimate software copies from running on hardware, whilst also providing a simple and cost effective implementation. Upon detection of non-authorised software, the present invention disables the hardware preventing further instructions from the software being implemented.

Preferably, the bus controller is arranged to receive an input signal by bonding the bus controller to a connection of the device, such that the input signal can enable the bus controller to detect the presence of the signature. This proves advantageous in that by utilising the configuration of the bonding, for example, for the integrated circuit die within the package, it is possible to define which integrated circuit devices are enabled to detect the presence of software and those which are not. This allows the use of a single die design, thereby removing the need and cost of manufacturing a die for detecting the presence of software and a die that does not detect the presence of software.

Additionally, by virtue of the features wherein the signature is written to internal registers, reverse engineering of the signature is greatly inhibited since it requires knowledge of which register contains the signature and where in the signature code the software is written to that register.

The present invention provides the further advantage that the end users of the hardware can develop software independently of a software producer and that can be executed on the processor device without danger of the above-mentioned disablement arising.

Preferably, internal registers are arranged to store the signature, and the bus controller is arranged to read the signature from the internal registers. This proves advantageous in that the signature can be updated by reprogramming the instruction registers and without the need to redesign the processor architecture.

A random parameter generator can be arranged to define a random delay between detection of the signature and the processor becoming disabled. This provides the advantage that the processor is disabled in a random and unpredictable manner and thereby further inhibiting reverse engineering.

According to another aspect of the present invention there is provided a method of detecting the use of software on a processor device, the method including the steps of detecting the presence of a signature contained in the software by way of a bus controller of the processor device and disabling the processor device by way of the bus controller upon detection of the said signature.

Preferably, in operation, the bus controller is arranged to receive an input signal by bonding the bus controller to an external connection of the device, such that the input signal enables the bus controller to detect the presence of the signature.

Preferably, the signature is written to instruction registers of the processor. The step of detecting the signature includes the step of reading the signature from internal registers using said bus controller. This proves advantageous in that the signature can be updated by reprogramming the instruction registers and bus controller and without the need to redesign the processor architecture.

Following the step of detecting the signature, the bus controller is disabled after a period of time which is determined in a random manner. This provides the advantage that the processor is disabled in a random and unpredictable manner thereby serving to inhibit reverse engineering.

According to another aspect of the invention, there is provided a method of manufacturing an integrated circuit device, the method comprising the steps of mounting a semiconductor die on a package, said semiconductor die containing a processor circuit and plurality of electrical contacts and said package including a plurality electrical contacts; bonding at least one of said plurality of electrical contacts of said processor to at least one of said plurality of electrical contacts of said package, whereby the said bonding serves to enable a bus controller of said processor to detect the presence of a signature contained in software and to disable the processor circuit by way of the bus controller upon detection of the said signature.

Advantageously, this provides the capability to enable, using a single die design, individual devices which can detect the presence of software, and conversely, define those devices, which cannot detect the presence of software.

The invention is described further hereinafter, by way of example only, with reference to the accompanying drawings, in which:

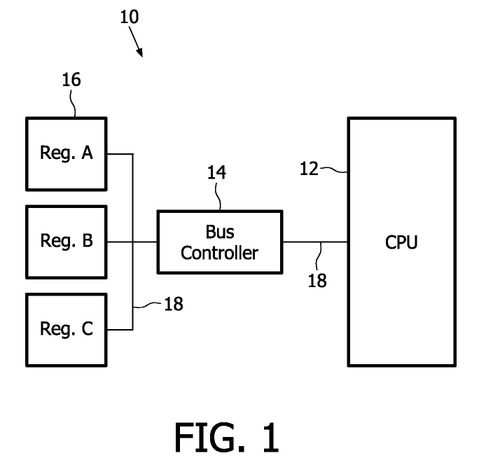

FIG. 1 illustrates a block diagram of a processor architecture embodying the present invention;

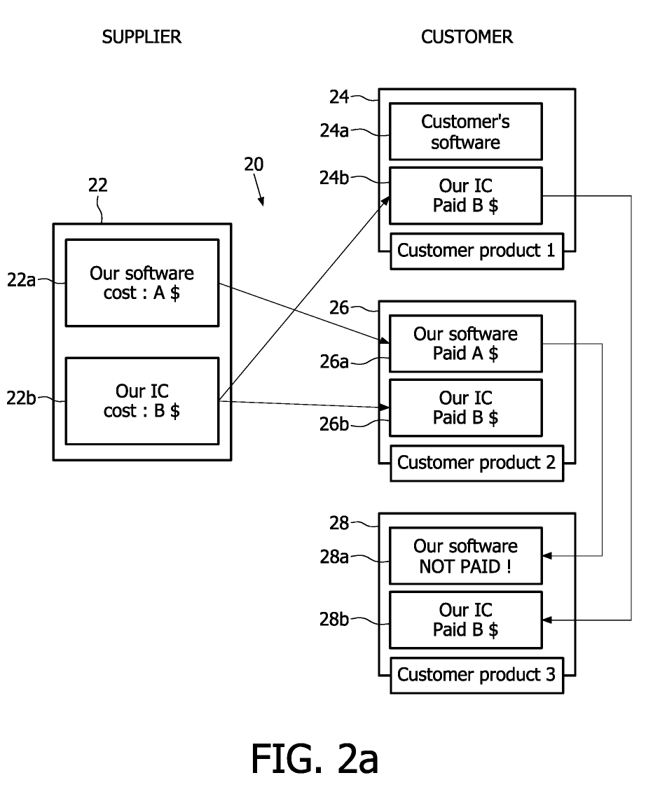

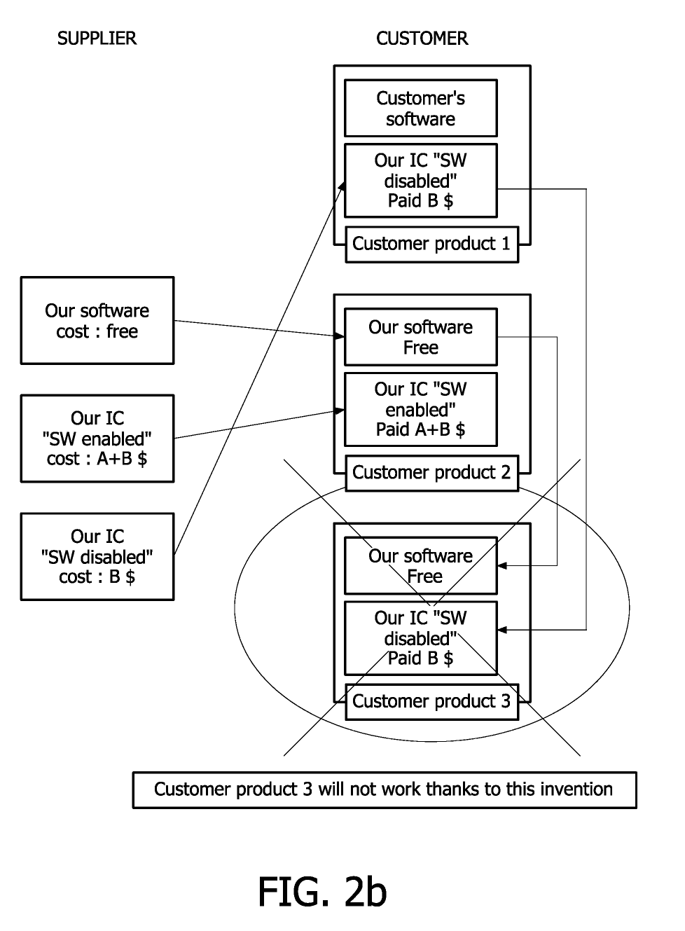

FIG. 2a illustrates a typical software/hardware supply chain embodying software and hardware according to the prior art; and

FIG. 2b illustrates a software/hardware supply chain incorporating an embodiment of the present invention.

In overview, the present invention provides for hardware devices such as processors that are arranged to detect the presence of specific software and then arranged to prevent the implementation of the instruction code of that software. Such hardware devices as those released by the hardware manufacturer can readily be arranged to prevent the subsequent use of specific software products therewith, such as copies of the hardware manufacturer's software.

Typically, processor devices of the type embodied in the present invention are formed as an integrated circuit package such as through-hole or surface mount packages. To form the integrated circuit, a silicon die or chip, on which the processor circuitry is defined, is mounted in a hermetically sealed ceramic package where the ceramic package includes external metallic pins for connection to a printed circuit board. Electrical contacts defined on the die, are connected or bonded to the metallic pins of the ceramic package using wires known as bonds, providing an electrical connection between the pins and each functional feature of the processor. Such functional features can include the CPU, registers and bus controller. The electrical connections provide input, output and power supply and other ancillary connections to the processor. By including or omitting bonds between the die and the external metallic pins of the package, it is possible to enable or disable functional features of a specific processor.

Bonding the input of the package to the bus controller allows the software detection feature of the present invention to be enabled by applying an electrical signal, such as a logical 1 or high, or alternatively a logical 0 or low could be used. Conversely, by not including such a bond it can be seen that the software detection feature can be readily disabled. By making use of the bonding regime discussed above only one die design needs to be produced, thereby greatly reducing device design and manufacturing costs and associated inefficiencies. Additionally, since the die is sealed within the package it is not possible to tamper with the device without damaging the processor, thus preventing the software protection feature from being disabled or reverse engineered.

The present invention is advantageous in that it can be implemented in relation to both processor hardware and software. The implementation in hardware makes it possible to define processors which cannot execute specific software such as that supplied by a particular software producer and copies thereof, and conversely, define those processor devices that can execute such software by modifying the bonding between the electrical package and the die. Such latter processor devices will generally be marketed along with the software product itself. Additionally, because the software is made up of stacks containing binary information it is difficult to determine which registers are programmed to store the signature, thereby providing protection against reverse engineering.

The present invention can be implemented in any appropriate processor architecture and can utilise any appropriate process to define which devices can detect the use of software. In an embodiment of the present invention shown schematically in FIG. 1, the processor 10 includes a central processing unit (CPU) 12, on which the instruction code of the software application runs, a bus controller 14 for controlling the operations of the CPU, and instruction registers 16 for storing the instruction code of the software. When the die or chip embodying the present invention is formed it includes an electrical connection to the bus controller of the processor. The bus controller includes means for detecting the presence of a specific software as discussed in more detail below. To enable the software detection feature of the bus controller it is necessary to provide a specific input signal to the electrical connection. Such a signal can be a logical 1, by connecting to a power supply. Alternatively, the signal can be logical 0 by connecting to ground. Therefore, to define which processors are enabled to detect the presence of a software it is necessary bond the electrical connection of the bus controller to the metallic pin of the ceramic package allowing the requisite signal (logical 1 or 0) to be present at the bus controller.

Each of the CPU 12, bus controller 14 and instruction registers 16 are programmed through a 32 data bus 18, however the data bus 18 can be of any appropriate size, for example 4, 8, 16 or 32 bits. The size of the instruction registers 16 can be less than or equal to that of the data bus. However, in an embodiment of the present invention a 32 bit data bus 18 and instruction registers 16 are used. Generally, for certain applications using 32-bit instruction registers or greater allows for some redundancy in the number of bits that the instruction registers require. By incorporating this redundancy it is possible to utilise unused bits of the instruction register so that they can be programmed with a signature which is unique to the processor type.

A signature, unique to the software is included in the instruction code. This can be written to unused internal instruction registers and stored in non-volatile memory such as flip-flops. The signature may be formed of any number of bits, for example 8, 16 or 32 bits, but generally the number of bits is chosen to be less than the number of bits of bus controller 14 of the processor device on which the software is implemented, so as to provide for ease of implementation.

A typical processor may be programmed through any number of 32 bit instruction registers and can include 50 or more such registers. As mentioned, there is some redundancy in one of the registers, providing a number of bits for processes other than executing the instruction code of the software. For example, supposing bits 31 to 12 of a specific 32 bit register are unused, then it can be seen that there are 20 available bits to write the signature to. Advantageously, by using this redundancy, it is possible to write information to the registers without changing the performance and behaviour of the processor.

In operation, the software is loaded onto the instruction registers 16 of the processor 10 prior to execution on the CPU 12. A unique address is predefined in software which corresponds to a specific bit of a preselected instruction register 16. By loading the software on to the instruction registers the specific bit of the preselected register is defined to be a logical 1 or ‘high’ to define the software signature. Such a write operation occurs during normal write access to the instruction registers. Whilst write operations to one specific bit have been described, it is contemplated however, that any number of bits may be programmed, thereby increasing the level of protection against reverse engineering.

If the required signal is provided at the bus controller, following the write operation to the instruction register 16, the bus controller 14 is then enabled to detect the logical state of the bit or bits that define the software signature. If the bus controller 14 detects the signature then the bus controller is disabled thereby disabling the entire system. Whilst a logical 1 or high is contemplated to define the signature it is possible to define the signature by writing any combination of logical 1's or 0's.

Optionally, when the bus controller 14 detects the signature it can continue to carry out additional operations as instructed by the instruction code of the software disabling the processor. The number of operations carried out following detection of the signature is defined by a random number generator implemented in hardware or software, and triggered by the bus controller 14 upon detection of the signature. In this way it can be seen that the processor 10 can be disabled in a random manner some time after detection of the signature, thereby making it difficult to determine at what point in code the bus controller was disabled.

By way of example, a typical processor is programmed through fifty internal registers. Among the registers, one is chosen. Bits 11 to 0 of that register are utilised for processing functions such as video processing. Therefore, bits 31 down to 12 of the chosen register are available to write the signature to. In this way it can be seen that writing the signature to unused registers will not change the behaviour of the processor. Specifically, for example, register number 28 is chosen. When writing to this register, the 32 bit data looks like: 0x00000000. 0x10000000 is written in the software defining the unique signature. This is detected by the bus controller and the processor disabled, as discussed. The end user of the software independently developing their code will never put logical ‘1’ in this bit at register number 28. By utilising this redundancy it possible to define a two or more bit signature so that the bus controller needs to recognise bits of the pre-identified address to which the signature is written to enable the protection. This reduces the chances of the user writing to those bits and triggering the protection should user of the hardware develop their own software.

Alternatively, if the bus controller 14 does not detect the presence of a signature, or the required electrical signal is not provided to the bus controller then the instruction code of the software will be executed in the normal manner and therefore, software, such as that developed independently of the hardware manufacturer, or software including the unique address can be executed on the processor without disabling the processor.

By way of example, the present invention will now be described by comparing a supply chain for hardware and software which does not incorporate the present invention with a supply chain for hardware and software incorporating the present invention.

FIG. 2a, comprises a block diagram of a typical scenario of an everyday supplier/customer supply chain 20 for the sale of hardware and/or software. The supplier 22 sells hardware 22b to a first customer 24, and independently of the supplier 22, customer 24 develops software for use on the hardware. Supplier 22 supplies a second customer 26 with hardware 22b and also the appropriate software 22a. The supply of this software can be subject to license agreements, preventing the customer from copying and resupplying to third parties. Independently of the supplier, the first customer 24 then supplies a third party 28 with the hardware 22a initially purchased from the supplier 22. Additionally, customer 26 supplies a copy of the software 22a purchased from the supplier to the same third party 28. Then, unbeknown to the original supplier 22, the third party 28 now has a complete hardware/software system, thus depriving supplier of revenue from sale of the appropriate software. Moreover, second customer 26 may be in breech of the license agreement by supplying the third party with a copy or original copy of the software.

FIG. 2b, depicts an analogous situation to that of FIG. 2a, in that the same chain of events of supply and resupply occur. As with the previous scenario the supplier supplies the customer with a standard hardware package, thereby allowing the first customer to develop their own software for use on that hardware. The second customer, on the other hand, purchases both the hardware and the associated software, and wherein the hardware in this case is enabled to execute the instructions of the suppliers' software as supplied therewith. As described in the above scenario, the first customer, independently of the supplier, supplies a third party with the hardware originally purchased from the supplier whilst, the second customer supplies a copy of software purchased from the supplier to the same third party. Contrary to the previous situation, however, by enabling the software detection feature of the present invention, any attempt to implement the copied software by the third party will cause the hardware supplied by the first customer to become disabled, thus rendering the software inoperable on that hardware. In this way it can be seen that the present invention provides for a cost effective way to distinguish between two hardware devices without the need to change the die or chip design. This can therefore enhance, in an efficient and effective manner, the control that a supplier of hardware and associated preferred software can exert over subsequent use of the hardware products.

Alternatively, it can also be contemplated that the present invention also prevents third parties from using specific software such as the suppliers' software on other forms of hardware.

In this way, it can be seen that the present invention provides a cost effective system and method for preventing the use of specific software with non-authorised hardware, which is simple and cost effective to implement, without the requirement and expense of redesigning the architecture of the processor hardware. Such non-authorised hardware being considered hardware that is supplied separately to the supplier's software and so which is not to be used therewith.

1. An integrated circuit device arranged for detecting the use of software thereon, the device including a processor device and a bus controller arranged to detect the presence of a signature contained in the software, and arranged such that detection of the signature by way of the bus controller serves to disable the processor device.

2. The device of claim 1, wherein the bus controller is further arranged to receive an input signal, such that the input signal enables the bus controller to detect the presence of the signature.

3. The device of claim 2, wherein the bus controller is arranged to receive the input signal by bonding to an external connection of said device.

4. The device of claim 1, wherein the processor device is arranged to be disabled by disabling the bus controller.

5. The device of claim 1, further comprising internal registers arranged to store the signature.

6. The device of claim 4, wherein the bus controller is arranged to read the signature from the internal registers.

7. The device of claim 1 in which the internal registers comprise instruction registers.

8. The device of claim 1, further comprising a random parameter generator arranged to define a random delay between detection of the signature and the processor becoming disabled.

9. The device of claim 8, wherein said generator is hardware implemented.

10. The device of claim 8, wherein said generator is software implemented.

11. A method of detecting use of software on a processor device, the method comprising:
detecting the presence of a signature contained in the software by way of a bus controller of the processor device; and
disabling the processor device by way of the bus controller upon detection of the said signature.

12. The method of claim 11, whereby the bus controller receives an input signal to enable the bus controller to detect the presence of the signature.

13. The method of claim 12, whereby the bus controller receives the input signal by bonding to an external connection of said device.

14. The method of claim 11, whereby the signature is written to instruction registers of the processor.

15. The method of claim 11, whereby detecting the signature includes the step of reading the signature from internal registers using said bus controller.

16. The method of claim 11, whereby following detection of the signature, the bus controller is disabled following a period of time where said period of time is determined in a random manner.

17. A method of disabling a processor and including a method of detecting use of software as claimed in claim 11.

18. A processor program comprising instructions for causing a processor to perform the method of claim 11.

19. A processor program of claim 18, stored on a computer readable medium.

20. A method of manufacturing an integrated circuit device, the method comprising;
mounting a semiconductor die on a package, said semiconductor die containing processor circuit and plurality of electrical contacts and said package including a plurality electrical contacts;
bonding at least one of said plurality of electrical contacts of said processor to at least one of said plurality of electrical contacts of said package;
whereby the said bonding enables a bus controller of said processor to detect the presence of a signature contained in software and to disable the processor by way of the bus controller upon detection of the said signature.
